(19) United States
(12) Patent Application Publication
(10) Pub. No.: US 2025/0133450 A1
(43) Pub. Date: Apr. 24, 2025

(54) METHOD AND APPARATUS FOR IMPROVING SERVICE CONTINUITY

(71) Applicant: MEDIATEK INC., Hsinchu City (TW)

(72) Inventors: Shang-Heh PAN, Hsinchu City (TW); Tsung-Ming LEE, Hsinchu City (TW); Tsung-Liang LU, Hsinchu City (TW)

(21) Appl. No.: 18/909,020

(22) Filed: Oct. 8, 2024

Related U.S. Application Data
(60) Provisional application No. 63/591,140, filed on Oct. 18, 2023.

(51) Int. Cl. H04W 36/00; H04L 27/26; H04W 36/36

(52) U.S. Cl. CPC H04W 36/0058; H04L 27/2656; H04W 36/362

(57) ABSTRACT

A method for improving service continuity is provided. The method is implemented by a reduced capability (RedCap) user equipment (UE) and includes generating a not-allowed cell list of new radio (NR) standalone (SA) cells. The method includes avoiding performing a mobility decision on the NR SA cells recorded in the not-allowed cell list during a mobility procedure or a measurement reporting procedure.

### CROSS REFERENCE TO RELATED APPLICATIONS

This application claims the benefit of U.S. Provisional Application No. 63/591,140, entitled “RedCap UE Service Continuity Failure Avoidance”, filed on Oct. 18, 2023, the entirety of which is incorporated by reference herein.

### BACKGROUND OF THE INVENTION

### Field of the Invention

The present disclosure generally relates to the field of mobile communication technology. More specifically, aspects of the present disclosure relate to a method and an apparatus for improving service continuity for reduced capability (RedCap) user equipment (UE).

### Description of the Related Art

Unless otherwise indicated herein, approaches described in this section are not prior art to the claims listed below and are not admitted as prior art by inclusion in this section.

In wireless communications, such as mobile communications under the 3rd Generation Partnership Project (3GPP) specification(s) for 5th Generation (5G) New Radio (NR), certain existing NR networks are deployed under the assumption that the minimum requirements as defined for a Release 15 (Rel-15) user equipment (UE) device are supported by all UEs that operate in the network. Such minimum requirements include, but are not limited to, a UE's operating bandwidth being at least 100 MHz and the minimum supported number of receiving (Rx) antennas at the UE being 2 or 4.

In 3GPP Release 17, a new type of UE called reduced capability (RedCap) UE (also known as NR-Light UE) was introduced. Generally, the RedCap UEs are associated with lower communicative capacity when compared to typical UEs (also called non-RedCap UEs), such as high-end UEs supporting enhanced mobile broadband (eMBB) and ultra-reliable low latency communications (URLLC) services. For example, the RedCap UEs may be limited in terms of maximum bandwidth (e.g., 20 MHz in Frequency Range 1 (FR1), 100 MHz in FR2, etc.), maximum transmission power (e.g., 20 dBm, 14 dBm, etc.), number of receiver antennas (e.g., 1 receiver antenna, 2 receiver antennas, etc.), and so on.

In order to support RedCap, 5G base stations need to be upgraded to the 3GPP Release 17 version. 5G base stations that only support R15 or R16 protocol versions do not support RedCap UEs' access. 5G base stations that do not support RedCap UE capabilities may send handover/redirection commands to move the RedCap UE to a non-RedCap capable cell. However, the RedCap UE cannot normally camp in a non-RedCap capable cell. The RedCap UE may continuously run into a mobility failure cycle under such an abnormal network scenario.

Therefore, there is a need for a method and an apparatus for improving service continuity to solve these problems.

### SUMMARY

The following summary is illustrative only and is not intended to be limiting in any way. That is, the following summary is provided to introduce concepts, highlights, benefits and advantages of the novel and non-obvious techniques described herein. Select, not all, implementations are described further in the detailed description below. Thus, the following summary is not intended to identify essential features of the claimed subject matter, nor is it intended for use in determining the scope of the claimed subject matter.

Therefore, the main purpose of the present disclosure is to provide a method and an apparatus for improving service continuity to prevent the RedCap UE from running into the mobility failure cycle continuously.

In an exemplary embodiment, a method for improving service continuity is provided. The method is implemented by a reduced capability (RedCap) user equipment (UE) and comprises generating a not-allowed cell list of new radio (NR) standalone (SA) cells; The method comprises avoiding performing a mobility decision on the NR SA cells recorded in the not-allowed cell list during a mobility procedure or a measurement reporting procedure.

In some embodiments, the step of generating the not-allowed cell list of NR SA cells further comprises one or more of the following: recording at least one first cell with a bandwidth greater than a predetermined value in the not-allowed cell list; recording at least one second cell on a specific frequency band in the not-allowed cell list; and recording at least one third cell that is non-RedCap capable in the not-allowed cell list according to system information block1 (SIB1) information.

In some embodiments, the predetermined value is 20 MHz.

In some embodiments, the specific frequency band is a time division duplexing (TDD) band or a frequency range 2 (FR2) band.

In some embodiments, the method further comprises generating a not-allowed frequency list of NR SA frequencies. The method further comprises recording a frequency in the not-allowed frequency list when more than a predetermined number of fifth cells recorded in the not-allowed cell list are on the frequency. The method further comprises avoiding performing the mobility decision on cells on the NR SA frequencies recorded in the not-allowed frequency list during the mobility procedure or the measurement reporting procedure.

In some embodiments, the not-allowed cell list of NR SA cells further comprises cell information of each cell recorded in the not-allowed cell list, wherein the cell information comprises: a frequency, a frequency band, a physical cell identifier (PCI), a global cell identifier (ID), and location information.

In some embodiments, the location information comprises global navigation satellite system (GNSS) information, a tracking area ID, a registration area ID, or a RAN-Based notification area ID.

In some embodiments, the step of avoiding performing the mobility decision comprises one of the following: avoiding selecting the NR SA cells recorded in the not-allowed cell list as candidate cells during the mobility procedure, wherein the mobility procedure comprises one of the following: selection, reselection, re-direction and conditional handover (CHO); and avoiding including the NR SA cells recorded in the not-allowed cell list into a measurement report during the measurement reporting procedure.

In some embodiments, the method further comprises removing a fourth cell from the not-allowed cell list after a time interval or when the RedCap UE is located within a threshold distance away from a range of the fourth cell.

In some embodiments, the method further comprises generating an allowed cell list of NR SA cells. The method further comprises selecting cells recorded in the allowed cell list as candidate cells during the mobility procedure.

In some embodiments, the method further comprises generating an allowed frequency list of NR SA frequencies. The method further comprises performing the mobility decision on the NR SA cells recorded in the allowed cell list during the mobility procedure or the measurement reporting procedure.

In an exemplary embodiment, an apparatus for improving service continuity is provided. The apparatus comprises a transceiver and a processor. The transceiver which, during operation, wirelessly communicates with at least one network node. The processor communicatively coupled to the transceiver such that, during operation, the processor performs operations comprising generating a not-allowed cell list of new radio (NR) standalone (SA) cells. The processor performs operations comprising avoiding performing a mobility decision on the NR SA cells recorded in the not-allowed cell list during a mobility procedure or a measurement reporting procedure.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (Iot) and Narrow Band Internet of Things (NB-IoT), Industrial Internet of Things (IIoT), beyond 5G (B5G), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the present disclosure, and are incorporated in and constitute a part of the present disclosure. The drawings illustrate implementations of the disclosure and, together with the description, serve to explain the principles of the disclosure. It should be appreciated that the drawings are not necessarily to scale as some components may be shown out of proportion to their size in actual implementation in order to clearly illustrate the concept of the present disclosure.

FIG. 1 is a diagram depicting an example scenario under schemes in accordance with implementations of the present disclosure.

FIG. 2 is a block diagram of an example communication system in accordance with an implementation of the present disclosure.

FIG. 3 is a flowchart of an example process in accordance with an implementation of the present disclosure.

### DETAILED DESCRIPTION OF THE INVENTION

Reference will now be made in detail to several embodiments. While the subject matter will be described in conjunction with the alternative embodiments, it will be understood that they are not intended to limit the claimed subject matter to these embodiments. On the contrary, the claimed subject matter is intended to cover alternative, modifications, and equivalents, which may be included within the spirit and scope of the claimed subject matter as defined by the appended claims.

Furthermore, in the following detailed description, numerous specific details are set forth in order to provide a thorough understanding of the claimed subject matter. However, it will be recognized by one skilled in the art that embodiments may be practiced without these specific details or with equivalents thereof. In other instances, well-known methods, procedures, components, and circuits have not been described in detail as not to unnecessarily obscure aspects and features of the subject matter.

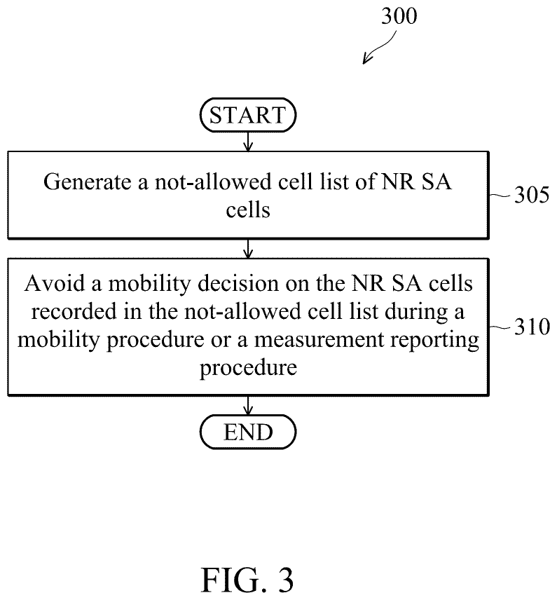

Portions of the detailed description that follow are presented and discussed in terms of a method. Although steps and sequencing thereof are disclosed in a figure herein (e.g., FIG. 3) describing the operations of this method, such steps and sequencing are exemplary. Embodiments are well suited to performing various other steps or variations of the steps recited in the flowchart of the figure herein, and in a sequence other than that depicted and described herein.

Some portions of the detailed description are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer-executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout, discussions utilizing terms such as “accessing,” “configuring,” “coordinating,” “storing,” “transmitting,” “authenticating,” “identifying,” “requesting,” “reporting,” “determining,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Some embodiments may be described in the general context of computer-executable instructions, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

### Overview

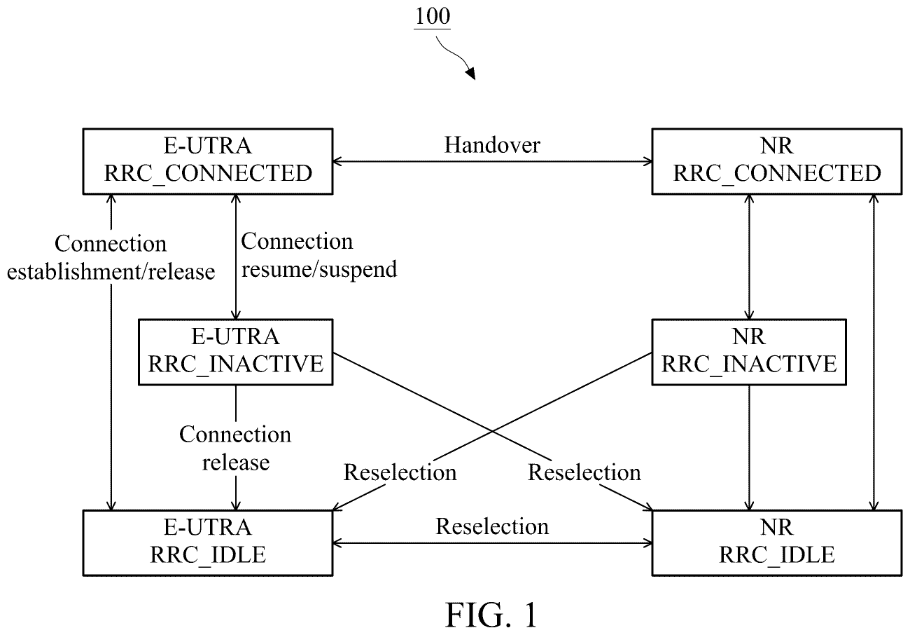

FIG. 1 illustrates an example scenario 100 under schemes in accordance with implementations of the present disclosure. Scenario 100 illustrates the mobility procedures between Evolved Universal Terrestrial Radio Access (E-UTRA) and NR for UE states and state transitions. A UE may perform a cell selection procedure after powering on to select a specific cell for initial registration. A UE is in radio resource control (RRC) CONNECTED when an RRC connection has been established or in RRC_INACTIVE when an RRC connection is suspended. If this is not the case, i.e., no RRC connection is established, the UE is in RRC_IDLE state. After the UE is camped on a cell and stays in RRC_IDLE mode, the UE may perform a cell reselection procedure to change cell. For the UE in RRC_CONNECTED mode, the UE may hand over an ongoing session from a source cell to a target cell by performing a handover procedure.

For a RedCap UE, it can only connect to an NR cell with RedCap capability which is indicated in NR SIB1 with IE intraFreqReselectionRedCap. However, before the UE can receive NR SIB1 form the NR cell, the UE needs to follow the NR neighbor cell information provided by the network side to measure NR neighbor cells and perform the cell reselection or handover to the NR cell when some criterias are met. In other words, in order to receive SIB1 from the NR cell, the UE must perform the cell measurements and transit to the NR cell first. The UE has no idea whether an NR cell supports RedCap capability without acquiring SIB1 from the NR cell. In some scenarios, after performing the cell measurements and transiting to the NR cell, the UE may find that the NR cell does not support RedCap capability (i.e., the NR cell is a non-RedCap capable NR cell). The suitability check will be failed if the NR cell does not support RedCap capability. Then, the UE needs to move/transit back to the LTE cell. This will cause a waste in power and time and unnecessary ping-pong effect between the two networks.

In view of the above, the present disclosure proposes several schemes for improving service continuity with respect to RedCap UE and network apparatus in mobile communications. According to the schemes of the present disclosure, a checking scheme will be introduced for determining whether an NR cell supports RedCap capability before performing a mobility decision. The RedCap UE or service provider may maintain a not-allowed cell list for recording NR SA cells that do not support RedCap capability. Whenever the RedCap UE needs to perform a mobility decision, the RedCap UE may acquire the not-allowed cell list of NR SA cells first to check whether an NR cell supports RedCap capability. In the event that an NR cell supports RedCap capability, the RedCap UE may perform a mobility decision on the NR cell. In the event that an NR cell does not support RedCap capability, the RedCap UE may avoid performing a mobility decision on the NR cell to save power and time. Accordingly, the RedCap UE may avoid unnecessary cell measurements and transitions. The power management and radio resource usage of the RedCap UE will be more efficient.

Specifically, the RedCap UE may be configured to generate a not-allowed cell list of NR SA cells. The generation methodology includes but is not limited to the following methods. (1) The RedCap UE records at least one first cell with a bandwidth greater than a predetermined value in the not-allowed cell list, wherein the predetermined value is 20 MHz. (2) The RedCap UE records at least one second cell on a specific frequency band in the not-allowed cell list, wherein the specific frequency band is a time division duplexing (TDD) band, a frequency range 2 (FR2) band or bands with a bandwidth greater than 20 MHz defined by each operator. (3) The RedCap UE records at least one third cell that is non-RedCap capable in the not-allowed cell list according to SIB1 information. For example, the RedCap UE may check whether the information element (IE) intraFreqReselectionRedCap is indicated in SIB1. In a case that the received SIB1 contains the IE intraFreqReselectionRedCap, it means that the cell is RedCap capable. The RedCap UE is allowed to camp on the cell. In a case that the received SIB1 does not comprise the IE intraFreqReselectionRedCap, it means that the cell is non-RedCap capable, and the RedCap UE may record the cell in the not-allowed cell list.

In some implementations, the RedCap UE may further record the cell information of each cell that is non-RedCap capable in the not-allowed cell list, wherein the cell information comprises a frequency, a frequency band, a physical cell identifier (PCI), a global cell identifier (ID) and location information, and the location information comprises global navigation satellite system (GNSS) information, a tracking area ID, a registration area ID, or a RAN-Based notification area ID to which the cell belongs. In addition, the RedCap UE may further determine whether to remove cells from the not-allowed cell list or add cells to the not-allowed cell list based on the location information. For example, when the RedCap UE detects that the network in an area has been upgraded to 3GPP Release 17 version, the UE may infer that other cells in this area have a high probability of being RedCap cells based on the location information and determine whether to remove those cells from the not-allowed cell list.

In some implementations, the mobility decision may comprise one of the following: selecting the cells recorded in the not-allowed cell list as candidate cells during the mobility procedure, wherein the mobility procedure comprises one of the following: selection, reselection, re-direction and conditional handover (CHO); and including the cells recorded in the not-allowed cell list into a measurement report during the measurement reporting procedure.

In some implementations, the RedCap UE may remove a fourth cell from the not-allowed cell list after a time interval or when the RedCap UE is located within a threshold distance away from the range of the fourth cell.

In some implementations, the RedCap UE may be configured to generate a not-allowed frequency list of NR SA frequencies. The generation methodology includes but is not limited to the following methods. (1) The RedCap UE records at least one first frequency with a bandwidth greater than the predetermined value in the not-allowed frequency list, wherein the predetermined value is 20 MHz. (2) The RedCap UE records at least one second frequency on a specific frequency band in the not-allowed frequency list, wherein the specific frequency band is a TDD band, a FR2 band or bands with a bandwidth greater than 20 MHz defined by each operator. (3) The RedCap UE records at least one third frequency in the not-allowed frequency list when more than a predetermined number of cells recorded in the not-allowed cell list are on the third frequency.

In some implementations, the RedCap UE avoids performing a mobility decision on cells on the NR SA frequencies recorded in the not-allowed frequency list during the mobility procedure or the measurement reporting procedure. Specifically, the RedCap UE may avoid selecting cells the NR SA frequencies recorded in the not-allowed frequency list as the candidate cells to avoid mobility failure during the mobility procedure, wherein the mobility procedure comprises one of the following: selection, reselection, re-direction and conditional handover (CHO). The RedCap UE may avoid to include cells on the NR SA frequencies recorded in the not-allowed frequency list into the measurement report during measurement reporting procedure. This is to avoid the network triggering further mobility decisions, such as handover (HO) or redirection.

In one implementation, to avoid reporting the cells that are non-Redcap capable to the network and potentially triggering a failure mobility procedure, the RedCap UE may attempt to receive the SIB1 information of potential candidate cell when performing connection state (NR intra-RAT or LTE inter-RAT) measurements on NR frequencies. When the RedCap UE confirms that the candidate cell has the RedCap capability, the RedCap UE includes the candidate cell in the measurement report. In some embodiments, the RedCap UE may further determine whether to perform the cell measurement or transit to a NR SA cell based on the quality of the NR SA cell (such as, RSRP, RSRQ, SINR, etc.) even though the NR SA cell is not recorded in the not-allowed cell list, to reduce the MIB/SIB acquisition failure rate due to weak signal quality or high interference during movement.

In some implementations, the RedCap UE may be configured to generate an allowed list of NR SA cells/frequencies. When a cell/frequency is listed in the allowed list, the RedCap UE may consider the cell/frequency as a candidate cell/frequency during the mobility procedure, or include cells or cells on the frequencies recorded in the allowed list into the measurement report during the measurement reporting procedure. The generation methodology includes but is not limited to the following methods. (1) The RedCap UE records at least one first cell/frequency with a bandwidth less than and equal to the predetermined value in the allowed list, wherein the predetermined value is 20 MHz. (2) The RedCap UE records at least one second cell/frequency on a specific frequency band in the allowed list, wherein the specific frequency band is a not TDD band, a FR2 band or bands with a bandwidth greater than 20 MHz defined by each operator. (3) The RedCap UE records at least one third cell that is RedCap capable in the allowed list according to SIB1 information. (4) The RedCap UE records at least one third frequency in the allowed list when more than a predetermined number of cells recorded in the allowed list are on the third frequency.

In some implementations, the RedCap UE may further record the cell information of each cell that is RedCap capable in the allowed list, wherein the cell information comprises a frequency, a frequency band, a PCI, a global cell ID and location information, and the location information comprises GNSS information, a tracking area ID, a registration area ID, or a RAN-Based notification area ID to which the cell belongs. In addition, the RedCap UE may further determine whether to remove cells from the allowed list or add cells to the allowed list based on the location information.

### Illustrative Implementations

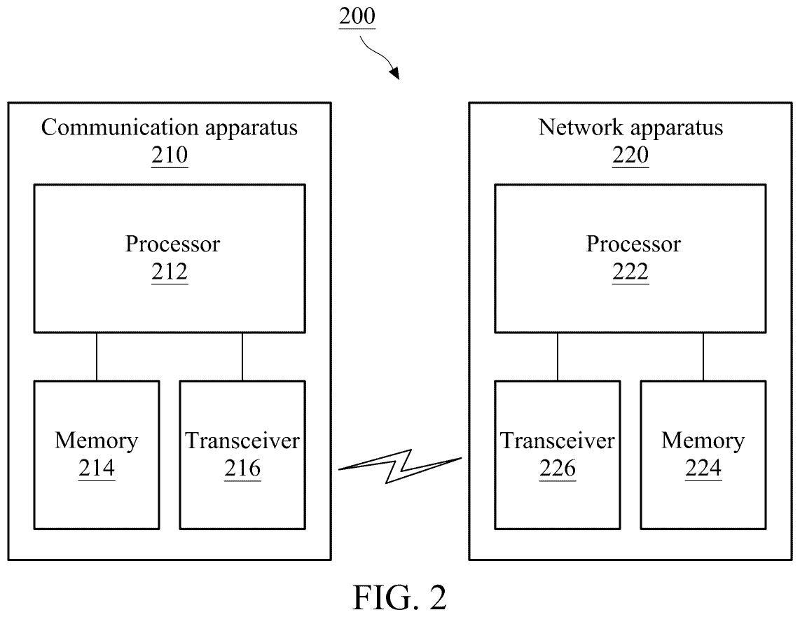

FIG. 2 illustrates an example communication system 200 having at least an example communication apparatus 210 and an example network apparatus 220 in accordance with an implementation of the present disclosure. Communication apparatus 210 and network apparatus 220 may each perform various functions to implement schemes, techniques, processes and methods described herein improving service continuity, including the various schemes described above with respect to various proposed designs, concepts, schemes, systems and methods described above, including process 300 described below.

Communication apparatus 210 and network apparatus 220 may each be a part of an electronic apparatus, which may be a network apparatus or a UE, such as a portable or mobile apparatus, a wearable apparatus, a vehicular device or a vehicle, a wireless communication apparatus or a computing apparatus. For instance, communication apparatus 210 and network apparatus 220 may each be implemented in a smartphone, a smart watch, a personal digital assistant, an electronic control unit (ECU) in a vehicle, a digital camera, or a computing equipment such as a tablet computer, a laptop computer or a notebook computer. Communication apparatus 210 and network apparatus 220 may also be a part of a machine type apparatus, which may be an loT apparatus such as an immobile or a stationary apparatus, a home apparatus, a roadside unit (RSU), a wire communication apparatus or a computing apparatus. For instance, Communication apparatus 210 and network apparatus 220 may be implemented in a smart thermostat, a smart fridge, a smart door lock, a wireless speaker or a home control center. When implemented in or as a network apparatus, communication apparatus 210 and network apparatus 220 may be implemented in an eNodeB in an LTE, LTE-Advanced or LTE-Advanced Pro network or in a gNB or TRP in a 5G network, an NR network, or an loT network.

In some implementations, communication apparatus 210 and network apparatus 220 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, communication apparatus 210 and network apparatus 220 may be implemented in or as a network apparatus or a UE. Communication apparatus 210 and network apparatus 220 may include at least some of those components shown in FIG. 2 such as a processor 212 and a processor 222, respectively, for example. communication apparatus 210 and network apparatus 220 may further include one or more other components not pertinent to the proposed scheme of the present disclosure (e.g., internal power supply, display device or user interface device), and, thus, such component(s) of communication apparatus 210 and network apparatus 220 are neither shown in FIG. 2 nor described below in the interest of simplicity and brevity.

In one aspect, each of processor 212 and processor 222 may be implemented in the form of one or more single-core processors, one or more multi-core processors, or one or more CISC or RISC processors. That is, even though a singular term “a processor” is used herein to refer to processor 212 and processor 222, each of processor 212 and processor 222 may include multiple processors in some implementations and a single processor in other implementations in accordance with the present disclosure. In another aspect, each of processor 212 and processor 222 may be implemented in the form of hardware (and, optionally, firmware) with electronic components including, for example and without limitation, one or more transistors, one or more diodes, one or more capacitors, one or more resistors, one or more inductors, one or more memristors or one or more varactors that are configured and arranged to achieve specific purposes in accordance with the present disclosure. In other words, in at least some implementations, processor 212 and processor 222 are special-purpose machines specifically designed, arranged and configured to perform specific tasks including those improving service continuity in accordance with various implementations of the present disclosure.

In some implementations, communication apparatus 210 may also include a transceiver 216 coupled to processor 212. Transceiver 216 may be capable of wirelessly transmitting and receiving data. In some implementations, transceiver 216 may be capable of wirelessly communicating with different types of wireless networks of different radio access technologies (RATs). In some implementations, transceiver 216 may be equipped with a plurality of antenna ports (not shown) such as, for example, four antenna ports. That is, transceiver 216 may be equipped with multiple transmit antennas and multiple receiver antennas for multiple-input multiple-output (MIMO) wireless communications. In some implementations, network apparatus 220 may also include a transceiver 226 coupled to processor 222. Transceiver 226 may include a transceiver capable of wirelessly transmitting and receiving data. In some implementations, transceiver 226 may be capable of wirelessly communicating with different types of UEs/wireless networks of different RATs. In some implementations, transceiver 226 may be equipped with a plurality of antenna ports (not shown) such as, for example, four antenna ports. That is, transceiver 226 may be equipped with multiple transmit antennas and multiple receiver antennas for MIMO wireless communications.

In some implementations, communication apparatus 210 may further include a memory 214 coupled to processor 212 and capable of being accessed by processor 212 and storing data therein. In some implementations, network apparatus 220 may further include a memory 224 coupled to processor 222 and capable of being accessed by processor 222 and storing data therein. Each of memory 214 and memory 224 may include a type of random-access memory (RAM) such as dynamic RAM (DRAM), static RAM (SRAM), thyristor RAM (T-RAM) or zero-capacitor RAM (Z-RAM). Alternatively, or additionally, memory 214 and memory 224 may each include a type of read-only memory (ROM) such as mask ROM, programmable ROM (PROM), erasable programmable ROM (EPROM) and electrically erasable programmable ROM (EEPROM). Alternatively, or additionally, memory 214 and memory 224 may each include a type of non-volatile random-access memory (NVRAM) such as flash memory, solid-state memory, ferroelectric RAM (FeRAM), magnetoresistive RAM (MRAM) and phase-change memory. Alternatively, or additionally, memory 214 and memory 224 may each include a UICC.

Communication apparatus 210 and network apparatus 220 may each be a communication entity capable of communicating with each other using various proposed schemes in accordance with the present disclosure. For illustrative purposes and without limitation, a description of the capabilities of communication apparatus 210, as a UE, and of network apparatus 220, as a network node (e.g., terrestrial network node or non-terrestrial network node) in a wireless network, is provided below.

Under certain proposed schemes in accordance with the present disclosure with respect to improving service continuity, processor 212 of communication apparatus 210, implemented in or as a UE, may generate a not-allowed cell list of NR SA cells. Processor 212 may avoid performing a mobility decision on the NR SA cells recorded in the not-allowed cell list during the mobility procedure or the measurement reporting procedure.

### Illustrative Processes

FIG. 3 illustrates an example process 300 in accordance with an implementation of the present disclosure. Process 300 may represent an aspect of implementing various proposed designs, concepts, schemes, systems and methods described above, whether partially or entirely, including those described above. More specifically, process 300 may represent an aspect of the proposed concepts and schemes improving service continuity. Process 300 may include one or more operations, actions, or functions as illustrated by one or more of blocks 305 and 310. Although illustrated as discrete blocks, various blocks of process 300 may be divided into additional blocks, combined into fewer blocks, or eliminated, depending on the desired implementation. Moreover, the blocks/sub-blocks of process 300 may be executed in the order shown in FIG. 3 or, alternatively in a different order. Furthermore, one or more of the blocks/sub-blocks of process 300 may be executed iteratively. Process 300 may be implemented by or in communication apparatus 210 and network apparatus 220 as well as any variations thereof. Solely for illustrative purposes and without limiting the scope, process 300 is described below in the context of communication apparatus 210 as a UE and network apparatus 220 as a communication entity such as a network node or base station (e.g., terrestrial network node or non-terrestrial network node) of a network. Process 300 may begin at block 305.

At block 305, process 300 may involve processor 212 of communication apparatus 210, generating a not-allowed cell list of new radio (NR) standalone (SA) cells. Process 300 may proceed from block 305 to block 310.

At block 310, process 300 may involve processor 212 avoiding performing a mobility decision on the NR SA cells recorded in the not-allowed cell list during a mobility procedure or a measurement reporting procedure.

In some implementations, in generating the not-allowed cell list of NR SA cells, process 300 may involve processor 212 performing one or more of the following: recording at least one first cell with a bandwidth greater than a predetermined value in the not-allowed cell list; recording at least one second cell on a specific frequency band in the not-allowed cell list; and recording at least one third cell that is non-RedCap capable in the not-allowed cell list according to system information block1 (SIB1) information.

In some implementations, process 300 may involve processor 212 generating a not-allowed frequency list of NR SA frequencies. Process 300 may involve processor 212 recording a frequency in the not-allowed frequency list when more than a predetermined number of fifth cells recorded in the not-allowed cell list are on the frequency. Process 300 may involve processor 212 avoiding performing mobility decision on cells on the NR SA frequencies recorded in the not-allowed frequency list during the mobility procedure or the measurement reporting procedure.

In some implementations, in avoiding performing mobility decision, process 300 may involve processor 212 performing one or more of the following: avoiding selecting the NR SA cells recorded in the not-allowed cell list as candidate cells during the mobility procedure, wherein the mobility procedure comprises one of the following: selection, reselection, re-direction and conditional handover (CHO); and avoiding including the NR SA cells recorded in the not-allowed cell list into a measurement report during the measurement reporting procedure.

In some implementations, process 300 may involve processor 212 removing a fourth cell from the not-allowed cell list after a time interval or when the RedCap UE is located within a threshold distance away from the range of the fourth cell.

In some implementations, process 300 may involve processor 212 generating an allowed cell list of NR SA cells. Process 300 may involve processor 212 selecting cells recorded in the allowed cell list as candidate cells during the mobility procedure.

Embodiments of the present disclosure provide a method and apparatus of wireless communications that improve service continuity. During 4G-to-5G inter-RAT mobility procedure, the Redcap UE may avoid proceeding the inter-RAT procedure to the non-RedCap cells, and keeps staying in the LTE cell. Specifically, the RedCap UE does not send eventB1/eventB2 report for the NR SA cell recorded in the not-allowed cell list. During the cell selection and reselection, the RedCap UE may skip the NR SA cell recorded in the not-allowed list to avoid running into mobility failure cycle continuously.

It should be understood that any specific order or hierarchy of steps in any disclosed process is an example of a sample approach. Based upon design preferences, it should be understood that the specific order or hierarchy of steps in the processes may be rearranged while remaining within the scope of the present disclosure. The accompanying method claims present elements of the various steps in a sample order, and are not meant to be limited to the specific order or hierarchy presented.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the disclosure has been described by way of example and in terms of the preferred embodiments, it should be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for improving service continuity, wherein the method is implemented by a reduced capability (RedCap) user equipment (UE), and comprises:
generating a not-allowed cell list of new radio (NR) standalone (SA) cells; and
avoiding performing a mobility decision on the NR SA cells recorded in the not-allowed cell list during a mobility procedure or a measurement reporting procedure.

2. The method for improving service continuity as claimed in claim 1, wherein the step of generating the not-allowed cell list of NR SA cells further comprises one or more of the following:
recording at least one first cell with a bandwidth greater than a predetermined value in the not-allowed cell list;
recording at least one second cell on a specific frequency band in the not-allowed cell list; and
recording at least one third cell that is non-RedCap capable in the not-allowed cell list according to system information block1 (SIB1) information.

3. The method for improving service continuity as claimed in claim 2, wherein the specific frequency band is a time division duplexing (TDD) band or a frequency range 2 (FR2) band.

4. The method for improving service continuity as claimed in claim 1, further comprising:
generating a not-allowed frequency list of NR SA frequencies;
recording a frequency in the not-allowed frequency list when more than a predetermined number of fifth cells recorded in the not-allowed cell list are on the frequency; and
avoiding performing the mobility decision on cells on the NR SA frequencies recorded in the not-allowed frequency list during the mobility procedure or the measurement reporting procedure.

5. The method for improving service continuity as claimed in claim 2, wherein the not-allowed cell list of NR SA cells further comprises cell information of each cell recorded in the not-allowed cell list;
wherein the cell information comprises:
a frequency;
a frequency band;
a physical cell identifier (PCI);
a global cell identifier (ID); and
location information.

6. The method for improving service continuity as claimed in claim 5, wherein the location information comprises global navigation satellite system (GNSS) information, a tracking area ID, a registration area ID, or a RAN-Based notification area ID.

7. The method for improving service continuity as claimed in claim 1, wherein the step of avoiding performing the mobility decision comprises one of the following:
avoiding selecting the NR SA cells recorded in the not-allowed cell list as candidate cells during the mobility procedure, wherein the mobility procedure comprises one of the following: selection, reselection, re-direction and conditional handover (CHO); and
avoiding including the NR SA cells recorded in the not-allowed cell list into a measurement report during the measurement reporting procedure.

8. The method for improving service continuity as claimed in claim 1, further comprising:
removing a fourth cell from the not-allowed cell list after a time interval or when the RedCap UE is located within a threshold distance away from a range of the fourth cell.

9. The method for improving service continuity as claimed in claim 1, further comprising:
generating an allowed cell list of NR SA cells; and
performing the mobility decision on the NR SA cells recorded in the allowed cell list during the mobility procedure or the measurement reporting procedure.

10. The method for improving service continuity as claimed in claim 1, further comprising:
generating an allowed frequency list of NR SA frequencies; and
performing the mobility decision on the NR SA cells recorded in the allowed frequency list during the mobility procedure or the measurement reporting procedure.

11. An apparatus for improving service continuity, comprising:
a transceiver which, during operation, wirelessly communicates with at least one network node; and
a processor communicatively coupled to the transceiver such that, during operation, the processor performs operations comprising:
generating a not-allowed cell list of new radio (NR) standalone (SA) cells; and
avoiding performing a mobility decision on the NR SA cells recorded in the not-allowed cell list during a mobility procedure or a measurement reporting procedure.

12. The apparatus for improving service continuity as claimed in claim 11, wherein the step of generating the not-allowed cell list of NR SA cells further comprises one or more of the following:
recording at least one first cell with a bandwidth greater than a predetermined value in the not-allowed cell list;
recording at least one second cell on a specific frequency band in the not-allowed cell list; and
recording at least one third cell that is non-RedCap capable in the not-allowed cell list according to system information block1 (SIB1) information.

13. The apparatus for improving service continuity as claimed in claim 12, wherein the specific frequency band is a time division duplexing (TDD) band or a frequency range 2 (FR2) band.

14. The apparatus for improving service continuity as claimed in claim 11 wherein, during operation, the processor further performs operations comprising:
generating a not-allowed frequency list of NR SA frequencies;
recording a frequency in the not-allowed frequency list when more than a predetermined number of fifth cells recorded in the not-allowed cell list are on the frequency; and
avoiding performing the mobility decision on cells on the NR SA frequencies recorded in the not-allowed frequency list during the mobility procedure or the measurement reporting procedure.

15. The apparatus for improving service continuity as claimed in claim 12, wherein the not-allowed cell list of NR SA cells further comprises cell information of each cell recorded in the not-allowed cell list;
wherein the cell information comprises:
a frequency;
a frequency band;
a physical cell identifier (PCI);
a global cell identifier (ID); and
location information.

16. The apparatus for improving service continuity as claimed in claim 15, wherein the location information comprises global navigation satellite system (GNSS) information, a tracking area ID, a registration area ID, or a RAN-Based notification area ID.

17. The apparatus for improving service continuity as claimed in claim 11, wherein the step of avoiding performing the mobility decision comprises one of the following:
avoiding selecting the NR SA cells recorded in the not-allowed cell list as candidate cells during the mobility procedure, wherein the mobility procedure comprises one of the following: selection, reselection, re-direction and conditional handover (CHO); and
avoiding including the NR SA cells recorded in the not-allowed cell list into a measurement report during the measurement reporting procedure.

18. The apparatus for improving service continuity as claimed in claim 11, wherein during operation, the processor further performs operations comprising:
removing a fourth cell from the not-allowed cell list after a time interval or when the RedCap UE is located within a threshold distance away from a range of the fourth cell.

19. The apparatus for improving service continuity as claimed in claim 11, wherein during operation, the processor further performs operations comprising:
generating an allowed cell list of NR SA cells; and
selecting cells recorded in the allowed cell list as candidate cells during the mobility procedure.

20. The apparatus for improving service continuity as claimed in claim 11, wherein during operation, the processor further performs operations comprising:
generating an allowed frequency list of NR SA frequencies; and
performing the mobility decision on the NR SA cells recorded in the allowed frequency list during the mobility procedure or the measurement reporting procedure.
